(19) United States
(12) Patent Application Publication
(10) Pub. No.: US 2023/0234351 A1
(43) Pub. Date: Jul. 27, 2023

(54) MAINTENANCE OF PRINTING DEVICES

(71) Applicant: Hewlett-Packard Development Company, L.P., Spring, TX (US)

(72) Inventors: Pere BARBER LLORENS, Sant Cugat del Valles (ES); Neha BANSAL, Bangalore (IN); Grainne COSTIGAN, Sant Cugat del Valles (ES); Jose Miguel IBANEZ BORAU, Sant Cugat del Valles (ES)

(73) Assignee: Hewlett-Packard Development Company, L.P., Spring, TX (US)

(21) Appl. No.: 18/007,165

(22) PCT Filed: Jul. 29, 2020
(86) PCT No.: PCT/US2020/043961

§ 371 Date: Jan. 27, 2023

(51) Int. Cl. B41J 2/045

(52) U.S. Cl. CPC B41J 2/0456; B41J 2/04536; B41J 2/04586

(57) ABSTRACT

Determining a need for maintenance of a printing device in large format printing is described in which historical performance data including ink consumption data relating to the printing device may be obtained. Threshold data based on the obtained historical performance data indicative of a need for maintenance of the printing device may be identified. Current performance data of the printing device may be monitored and may be used to determine whether the current performance data exceeds the identified threshold data indicative of a need for maintenance of the printing device.

### BACKGROUND

Images are processed for use with computing machines, such as a printing device. A printing device may comprise a print carriage with an impelling motor for the purpose of reproducing a physical representation of an image on a recorded medium.

A printing device may be provided in a high-productivity printing environment, where it is desirable to avoid halting of print production. Keeping a printing device working so as to avoid halting of print production may involve periodic/routine maintenance. Furthermore, a printing device may need to be maintained at unscheduled time periods to avoid damage to the printing device, and in turn avoiding a halt of print production.

### BRIEF DESCRIPTION OF THE DRAWINGS

FIG. 1 is an example printing system according to the present disclosure.

FIG. 2 is a schematic diagram showing components of a controller according to an example.

FIG. 3 is a flow diagram showing a method of determining whether a printing device needs to be maintained according to an example.

FIG. 4 is an example of a computer readable medium comprising instructions to determine whether a printing device needs to be maintained according to an example.

### DETAILED DESCRIPTION

In order to reproduce a physical representation of an image on a recorded medium, the print carriage of the printing device is controllable to be moved across a scan axis of the printing device in a controlled movement. In an example, the movement of the print carriage is permitted via carriage rails and a carriage belt. In order to have accurate and controlled movement the carriage rails and carriage belt are to be maintained so as to prevent damage and a subsequent halting of print production. In an example, the carriage rails may need to be kept free of dust and debris and correctly lubricated, and the carriage belt may need to be properly tightened.

A printing device may have maintenance performed based on variables such as the ink usage i.e. every 1000 litres, however, depending on the usage and the printing environment of the printing device, this scheduled maintenance may be insufficient. In examples provided herein, a printing device may provide notifications regarding a need for maintenance. The notifications may be provided at a time point when it is determined that the printing device is in need of maintenance and/or at a time period ahead of when it is determined that the printing device may sustain damage as a result of not being maintained in due time. Accordingly, the printing device may prevent damage to components by alerting for service/replacements in advance, thus a user does not need to attempt to anticipate when maintenance is needed. Thus, example printing devices may avoid the need for performing maintenance too frequently, and avoid excessive application of maintenance procedures. Conversely, examples may provide notifications when they are appropriate, without causing a user to ignore a routine maintenance message that may or may not yet apply, leading to user complacency and risk of missing legitimate issues and causing permanent damage and/or failure. Example maintenance procedures may comprise determining whether components should be serviced, greased, tightened, loosened, adjusted, re-seated, etc., or whether any mechanical part is nearing damage.

Predictive notifications may be based on obtained performance data of the printing device. In an example the performance data may be Pulse Width Modulation (PWM) readings from the motor, which give a measure of the power applied to the motor to move the print carriage across the scan axis of the printer. Unmaintained print carriage rails and carriage belt may result in a higher level of power being needed to move the print carriage to overcome the resistive forces due a build-up of dust and debris. In an example, a higher values of PWM readings may indicate a greater need for maintenance of the printing device. Periodic measurements of PWM readings, for example at a predetermined frequency of once a day, may be obtained during a first media load - a process in the high-productivity printing environment for checking the edges of the recorded medium. During the first media load, the print carriage may be controllable to move from one side of the scan axis of the printing device to the other. Once the movement of the print carriage is completed, the recorded medium may be controllable to advance relative to the scan axis of the printing device. Each instance of the movement of the print carriage may be performed at the same speed and covering the same distance at every periodic measurement, and PWM data relating to the movement may be obtained. In an example, the obtained PWM data may be of average PWM, standard deviation of PWM, and maximum and minimum PWM.

In another example, the performance data may be ink consumption data. The amount of ink consumed by the printing device may be obtained in periodic measurements. The obtained measurements of ink consumption may be stored as ink consumption data in a memory unit of the printing device. Ink consumption data may be indicative of the rate of use of the printing device. In an example, a higher level of ink consumption may indicate that the printing device has been used more frequently within a given period of time. The ink consumption data is not limited to being stored in a memory unit of the printing device and may be stored in any data storage device such as a cloud based device that may store a database with performance data.

In another example, the obtained performance data may be recorded as maintenance service data which is representative of data relating to maintenance performed on the printing device. Whenever the printing device is maintained, and/or an error has been identified by the printing device and/or parts of the printing device have been replaced due to damage, this may be logged as a maintenance service data entry. Any printer errors associated with the print carriage of the printing device may also be logged as a maintenance service data entry. The maintenance service data may be stored in a memory unit of the printing device. The maintenance service data is not limited to being stored in a memory unit and may be stored in any data storage device such as in a cloud based database.

In yet another example, the obtained performance data may be printing device data including scan axis cycle data. The scan axis cycle data shows how many times the print carriage has performed a scan axis cycle (a single movement across the scan axis of the print carriage and back) over a predetermined period of time. In an example, the scan axis cycle data may indicate a higher use of the printing device as a higher value of scan axis cycles correlates to more prints being performed by the printing device. The obtained measurements may be stored as scan axis cycle data in a memory unit of the printing device. The scan axis cycle data is not limited to being stored in a memory unit and may be stored in any data storage device such as in a cloud based database.

The obtained performance data is not limited to being PWM data, ink consumption data, maintenance service data, and scan axis cycle data. The obtained performance data may be any data which indicates a performance measure of the printing device.

An example printing device may use machine learning techniques in order to determine when the printing device is in need of maintenance. Based on a sample set of historical performance data obtained from the printing device over a predetermined period of time, predictions about when the printing device is in need of maintenance may be made by learning, from the historical performance data, the precise values of PWM data, ink consumption data, and/or scan axis cycle data which are indicative of the printing device being in need of maintenance. In an example, the historical performance data may be obtained from a plurality of printing devices.

An example form of a machine learning technique that may be used is decision tree learning. In decision tree learning, a decision tree is used as a predictive model which, over several iterations, reduces an initial set of data into subsets of data which best fits the target parameters of a given variable. In an example, a decision tree may have multiple levels, where each level may have multiple variables, and each variable may be given a target value.

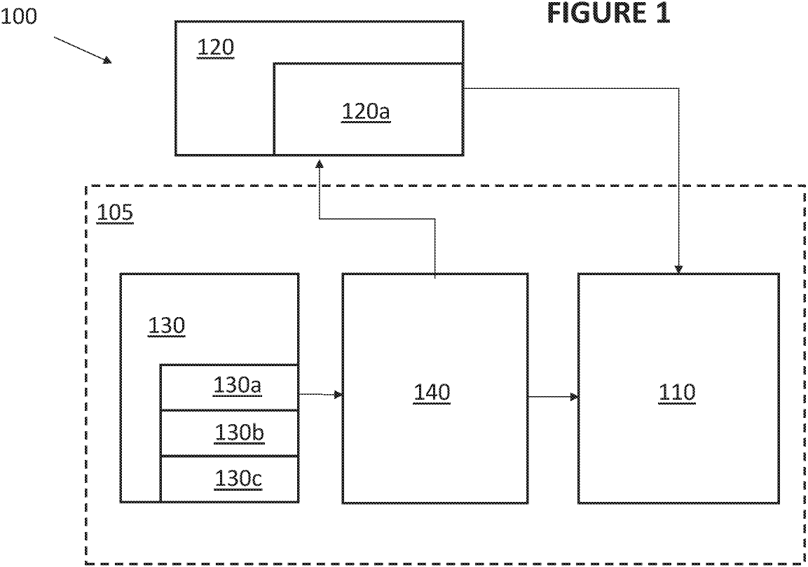

With reference to FIG. 1, there is shown an example printing system 100 according to the present disclosure. The printing system 100 comprises a printing device 105 and a performance database 120. The printing device 105 further comprises a controller 110, a print carriage 130, and current performance data 140.

The controller 110 is controllable to obtain historical performance data 120a from the performance database 120. The historical performance data 120a may comprise performance data relating to the printing device 105 which has been stored over a predetermined period of time. In an example, the performance data of the printing device 105 may be stored as historical performance data 120a in the performance database 120 at predetermined intervals from when the printing device 105 was first initiated. In an example, the historical performance data 120a may be data related to a plurality of printing devices including printing device 105. In an example, the performance database 120 may be provided in a server remote from the location of the controller 110. In an example, the server may be a part of a cloud computing network. In a further example, the performance database 120 may be located in a memory unit of the controller 110. The performance database 120 is not limited to being located in the remote server or a memory unit. The performance database 120 may be located in any location where data can be stored. The performance database 120 may send data to or receive data from the controller 110 via a wired or wireless connection. In an example, the historical performance data 120a received by the controller 110 may be pulse width modulation (PWM) data. In an example, the PWM data may be delta PWM which is an amplitude of average PWM readings within a given time period, mean average PWM, and/or maximum standard deviation of PWM. In another example, the historical performance data 120a may be ink consumption data. In another example, the historical performance data 120a may be maintenance service data. In yet another example, the historical performance data 120a may be scan axis cycle data.

Still referring to FIG. 1, the controller 110 of printing device 105 is controllable to obtain current performance data 140 relating to the printing device 105. The current performance data 140 may comprise ink consumption data, maintenance service data, scan axis cycle data, and/or PWM data from the printing device 105. In an example, the PWM data may be obtained from the print carriage 130. The print carriage 130 may comprise carriage rails 130a and a carriage belt 130b. The print carriage 130 may further comprise an impelling motor 130c controllable to move carriage belt 130b and subsequently moving the print carriage along the carriage rails 130a. In an example, the PWM data obtained from the print carriage 130 is the PWM data output by the impelling motor 130c of the print carriage 130. In an example, the PWM data may be delta PWM, mean average PWM, and/or maximum standard deviation of PWM.

In an example, the current performance data 140 may be stored in the performance database 120. The PWM data, ink consumption data, maintenance service data, and/or scan axis cycle data that is obtainable from the printing device 105 may be stored in the performance database 120 as historical performance data 120a. In an example, the current performance data may be stored in the performance database at a predetermined time.

In an alternative example, the controller 110 may be provided in a location remote from the printing device 105. The controller 110 may be a part of a cloud computing network. The controller 110 is not limited to being located in the printing device 105, a location remote from the printing device 105, or a cloud computing network. The controller 110 may be located in any location where data can be processed or instructions can be carried out.

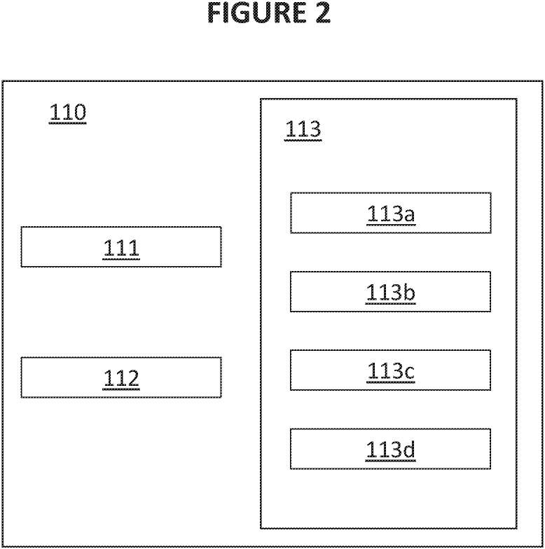

With reference to FIG. 2, the controller 110 may comprise a plurality of components, some of which are described below. The controller may be a programmable logic device (PLD) or other computing device that can carry out instructions. The controller may include one or multiple processing elements that are integrated in a single device as described in the example below or distributed across devices.

The controller 110 of the printing device 105 may comprise a data input/output interface unit 111 to receive the current performance data 140 and the historical performance data 120a from the performance database 120. In an example the input/output interface unit 111 may receive input data from external components, for example, user input devices (not shown) to allow a user to interact with the system 100. The input/output interface unit 111 may also output data from the controller 110 to the performance database 120, and external components, for example, such as a display unit (not shown).

The controller 110 may further comprise a processor 112 to manage all the components within the controller 110, and process all data flow between the components within the controller 110. The processor may be any of a central processing unit, a semiconductor-based microprocessor, an application specific integrated circuit (ASIC), and/or other device suitable for retrieval and execution of instructions.

The controller 110 may further comprise a storage or memory unit 113 to store any data or instructions which may need to be accessed by, for example, the processor 112. The memory unit 120 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

Referring to FIGS. 1 and 2, in one example, the memory unit 113 may include instructions to cause the processor 112 to carry out actions. The instructions can be: to obtain 113a historical performance data including ink consumption data relating to a printing system; to identify 113b threshold data indicative of a maintenance condition of the printing system based on the historical performance data; to monitor 113c current performance data relating to the printing system; and to determine 113d whether the current performance data exceeds the identified threshold data.

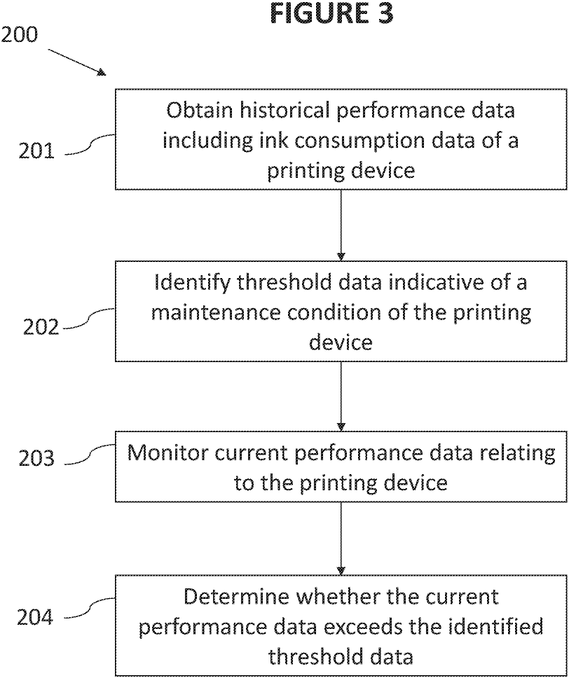

Reference is now made to FIG. 3 which shows an example method 200 of determining whether a printing device needs to be maintained according to the present disclosure and to FIG. 2 which refers to the elements in an example controller 110. Method 200 starts with block 201 - obtaining historical performance data 120a including ink consumption data relating to a printing device. The historical performance data 120a may be obtained from the performance database 120 by the controller 110, via the input/output interface unit 111 of the controller 110. In an example, the obtained historical performance data 120a may be stored in the memory unit 113 of the controller 110. The obtained historical performance data 120a may be PWM data, ink consumption data, maintenance service data, and/or scan axis cycle data of the printing device 105. The obtained historical performance data 120a may have been stored in the performance database 120 over a predetermined period of time. In an example, the current performance data 140 of the printing device 105, comprising PWM data, ink consumption data, maintenance service data, and/or scan axis cycle data, may be stored as historical performance data 120a in the performance database 120 at predetermined time intervals. In an example, the predetermined time intervals may be on a daily basis. In an example, the historical performance database 120a may comprise performance data relating to a plurality of printing devices including printing device 105.

Block 202 of method 200 comprises identifying threshold data indicative of a maintenance condition of the printing device based on the obtained historical performance data 120a. The controller 110 of the printing device 105 is controllable to obtain the historical performance data 120a from the performance database 120, and via the processor 112, identify threshold data indicative of the printing device 105 being in need of maintenance. In an example, the processor 112 of the controller 110 may identify the threshold data using a machine learning technique such as a decision tree. The following is an example method of how the processor 112 of the controller 110 may identify threshold data using a decision tree.

Starting with all the data entries of historical performance data 120a which have been obtained from performance database 120, the processor 112 may, in an example, first group the data entries based on the ink consumption data. In an example, a predetermined value of ink consumption data may be selected which represents a low level of ink consumption over a predetermined period of time. In an example, the predetermined period of time may be a period of 1 week. A low level of ink consumption may be indicative of the printing device 105 not being used at regularly, thus resulting in an increased build-up of dust and debris in the carriage rails 130a of the print carriage 130 of the printing device 105. The processor 112 may identify and create an initial sub-group of data entries of the historical performance data 120a which have a value of ink consumption which is less than or equal to a predetermined value indicative of a low usage of the printing device 105. The decision tree is not limited to first group the data based on ink consumption, and may initially group the data based on any data variable, for example - PWM data, ink consumption data, and/or scan axis cycle data.

Continuing on from the above example where the decision tree creates an initial sub-group based on ink consumption, once the initial sub-group of the historical performance data 120a which have a value of ink consumption which is less than or equal to a predetermined value indicative of a low usage of the printing device 105 have been identified, the processor 112 may further identify a sub-sub-group of the historical performance data - this time based on a predetermined value of any of PWM data or scan axis cycle data. In an example, the sub-sub-group may be based on different types of PWM data such as delta PWM, mean average PWM or maximum standard deviation of PWM. In an example, the processor 112 may identify subsequent sub-groups based on the different types of PWM data or the scan axis cycle data, further splitting the data set of the historical performance data 120a with every new sub-group of data.

After the final sub-group of the historical performance data 120a has been identified, the processor 112 may identify the probability of the printing device 105 needing maintenance and/or needing replacement of parts of the printing device 105. This probability of needing maintenance and/or needing replacement of parts is dependent on all the sub-groups, as the final set of historical performance data 120a has been reduced as a result of the processor 112 splitting the total number of data entries based on the previous sub-groups.

In an example, the processor may change the predetermined values of ink consumption data, PWM data and scan axis cycle data and perform the reduction of the historical performance data again. The ink consumption data may be decremented to find a lower value of ink consumption data resulting in a need for maintenance of the printing device 105. The PWM data and scan axis cycle data may be incremented to find a higher value of PWM data and scan axis cycle data resulting in a need for maintenance of the printing device 105. In an example, the processor 112 may repeat this process iteratively to find the minimum value of ink consumption data and/or maximum values of PWM and/or scan axis cycle data which would result in a need for maintenance of the printing device 105.

In an example, the maximum and/or minimum values of historical performance data 120a may be identified by the processor 112 as the threshold data indicative of the printing device 105 being in need of maintenance. In another example, the processor 112 may identify the maximum and/or minimum values of the historical performance data 120a and determine threshold values higher and/or lower than the identified maximum and/or minimum values. In an example, the degree to which the threshold values are higher and/or lower may be based on predetermined error margins.

The processor 112 of the controller 110 may determine, from the obtained historical performance data 120a, if the printing device 105 has been maintained and/or has had parts replaced based on the maintenance service data. If the printing device 105 has been maintained recently, this may be indicative of the printing device 105 not being in need of further maintenance. In an example, the processor 112 may identify that the printing device has been maintained recently and make an initial determination that the printing device 105 is not in need of maintenance. Even though the initial determination may indicate that there is no need for maintenance, a printing device in high-productivity printing environment may need to be maintained more regularly depending on the environment. In an example, the controller 110 may perform further processing to determine if the printing device 105 is in need for maintenance as explained below.

Block 203 of method 200 comprises monitoring current performance data 140 of the printing device. The controller 110 may obtain current performance data 140 of the printing device 105 via the input/output interface unit 111 of the controller 110. In an example, the obtained current performance data 140 may be stored in the memory unit 113 of the controller 110. The current performance data 140 may comprise ink consumption data, maintenance service data, scan axis cycle data, and/or PWM data from the printing device 105. The controller 110 may obtain the current performance data at predetermined time intervals. In an example, the predetermined time intervals may be at a frequency of once a day. The controller 110 may obtain the current performance data 140 and, via the processor 112, monitor the values of the current performance data 140 in relation to the identified threshold values indicative of a need for maintenance of the printing device 105.

Block 204 of method 200 comprises determining whether the current performance data 140 exceeds the identified threshold data indicative of a need for maintenance of the printing device. The processor 112 of controller 100 may compare the obtained current performance data 140 with the identified threshold data. In an example, the processor may determine that the values of ink consumption data, PWM data, and scan axis cycle data have exceeded (or met) the determined threshold values. In this example, this is indicative of the printing device 105 being in need of maintenance. If it is determined that the printing device 105 in need of maintenance, the processor 112 may instruct the controller 110 to output an alert signal indicative of the printing device 105 being in need of maintenance. In an example, this signal may be outputted via the input/output interface unit of the controller 110 to a user display (not shown). In another example, the signal may be in the form of an audible alert signal. The alert signal is not limited to being a signal to a user display, or an audible signal. The signal may be any form of signal to indicate that the printing device 105 is in need of maintenance and may, for example, be a signal sent to a remote server.

The current performance data 140 may be stored in the performance database 120 as historical performance data 120a, thereby updating the performance database 120. In an example, the controller 110 may obtain the updated historical performance data 120a and identify updated threshold data indicative of a need for maintenance of the printing device 105. In an example, this update may be performed at predetermined time intervals.

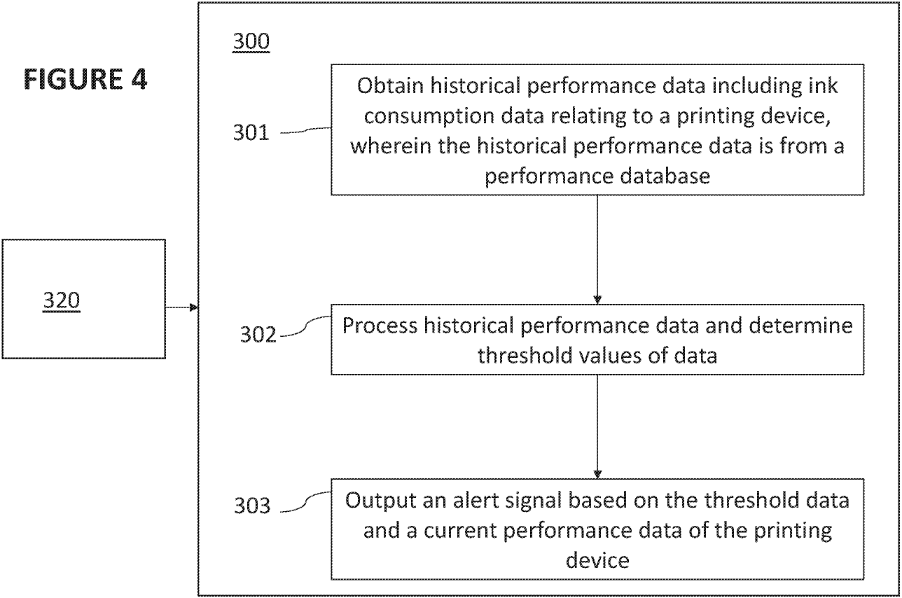

FIG. 4 shows a memory 300, which is an example of a computer readable medium storing instructions 301, 302, and 303 that, when executed by a processor 320 communicably coupled to a computing device, may cause the processor 320 to determine whether a printing device needs to be maintained in accordance with any of the examples or the flow diagram described above. Instruction 301 is to obtain historical performance data including ink consumption data relating to a printing device, wherein the historical performance data is from a performance database. Instruction 302 is to process the historical performance data using a machine learning technique to determine threshold values of data relating to a condition of the printing device. Instruction 303 is to output an alert signal based on the threshold data and a current performance data of the printing device. The computer readable medium may be any form of storage system capable of storing executable instructions, such as a non-transient computer readable medium, for example Random Access Memory (RAM), Electrically-Erasable Programmable Read-Only Memory (EEPROM), a storage drive, an optical disc, or the like.

1. A method comprising:
obtaining historical performance data including ink consumption data relating to a printing device;
identifying threshold data indicative of a maintenance condition of the printing device based on the historical performance data;
monitoring current performance data relating to the printing device;
determining whether the current performance data exceeds the identified threshold data.

2. The method of claim 1, wherein the obtained historical performance data including ink consumption data further comprises data relating to a plurality of printing devices.

3. The method of claim 1, wherein the historical performance data further comprises pulse width modulation (PWM) data, maintenance service data, and/or scan axis cycle data obtained from the printing device.

4. The method of claim 3, wherein the historical performance data further comprises the maintenance service data and the maintenance service data comprises a data entry relating to when the printing system has been maintained and/or a part of the printing system has been replaced due to damage, and/or logged printer errors.

5. The method of claim 1, wherein identifying threshold data comprises:
identifying data entries of the historical performance data which have a value less than or equal to a predetermined value;
adjusting the predetermined value by incrementing or decrementing the predetermined value; and
repeating the identification and adjusting steps until a value of the historical performance data indicative of the maintenance condition of the printing system is identified.

6. The method of claim 1, wherein the method further comprises updating the historical performance data to include current performance data and identifying updated threshold data relating to the maintenance condition of the printing devices.

7. The method of claim 1, wherein the method further comprises sending an alert based on the determination of current performance data exceeding the identified threshold data.

8. The method of claim 1, wherein the PWM data comprises delta PWM, mean average PWM, and/or maximum standard deviation of PWM.

9. A printing system comprising a controller, wherein the controller is to:
obtain historical data relating to a printing device from a performance database;
obtain threshold data relating to a condition of the printing device, wherein the threshold data is based on the obtained historical performance data;
output an alert signal based on the obtained threshold data and current performance data of the printing device.

10. The system of claim 9, wherein the performance database comprises data relating to pulse width modulation (PWM) data, ink consumption data, and/or maintenance service data of the printing system.

11. The system of claim 9, wherein the controller is to obtain threshold data by processing the historical data to identify a value of historical data relating to the condition of the printing device.

12. The system of claim 9, wherein outputting the alert comprises determining whether the current performance data has exceeded the value based on the determined threshold data.

13. A non-transitory computer-readable medium comprising instructions, which when executed on a computing device, causes the computing device to:
obtain historical performance data including ink consumption data relating to a printing device, wherein the historical performance data is from a performance database;
process the historical performance data using a machine learning technique to determine threshold values of data relating to a condition of the printing device;
output an alert signal based on the threshold data and a current performance data of the printing device.

14. The non-transitory computer-readable medium of claim 13, wherein the processing of the historical performance data using the machine learning technique further comprises:
identifying data entries of the historical performance data which have a value less than or equal to a predetermined value;
adjusting the predetermined value by incrementing or decrementing the predetermined value; and
identifying a value of the historical data indicative of a point of failure of the printing device.

15. The non-transitory computer-readable medium of claim 13, wherein the threshold data comprises a value of current performance data which when exceeded triggers the printing device to output the alert.
